(19) United States
(12) Patent Application Publication
(10) Pub. No.: US 2026/0295850 A1
(43) Pub. Date: Oct. 1, 2026

(54) VISUAL SERVO TRACKING METHOD FOR ROBOTIC ARM, DEVICE, MEDIUM, PRODUCT, AND ROBOT

(71) Applicant: TAIZHOU UNIVERSITY, Taizhou (CN)

(72) Inventors: Pengzhan CHEN, Taizhou (CN); Fengze XU, Taizhou (CN); Xuan ZHENG, Taizhou (CN); Liming LAO, Taizhou (CN); Yongchao ZHANG, Taizhou (CN); Yong GUAN, Taizhou (CN); Zhixiong WU, Taizhou (CN)

(73) Assignee: TAIZHOU UNIVERSITY, Taizhou (CN)

(21) Appl. No.: 19/443,547

(22) Filed: Jan. 8, 2026

(30) Foreign Application Priority Data
Mar. 25, 2025 (CN) 202510361590.9

(51) Int. Cl. B25J 9/16; B25J 9/12

(52) U.S. Cl. CPC B25J 9/1697; B25J 9/126

(57) ABSTRACT

The present application provides a visual servo tracking method for a robotic arm, a device, a medium, a product, and a robot, and relates to the field of robotic visual tracking. The method includes: obtaining a target position in real time based on machine vision to generate target position data; constructing a position prediction model by using a controlled autoregressive integrated moving average (CARIMA) model; generating a predicted value of the target position based on the target position data by using the position prediction model, and correcting the predicted value of the target position based on real-time feedback of target movement to obtain a predicted target position; and adjusting a motion trajectory of the robotic arm based on an error between the predicted target position and a current target position of the robotic arm.

### CROSS REFERENCE TO RELATED APPLICATION

This patent application claims the benefit and priority of Chinese Patent Application No. 202510361590.9, filed with the China National Intellectual Property Administration on Mar. 25, 2025, the disclosure of which is incorporated by reference herein in its entirety as part of the present application.

### TECHNICAL FIELD

The present application relates to the field of robotic visual tracking, and in particular, to a visual servo tracking method for a robotic arm, a device, a medium, a product, and a robot.

### BACKGROUND

With the development of industrial automation and intelligent manufacturing technologies, robotic arms are widely used in various tasks, especially in target tracking and grabbing in dynamic environments. However, the conventional visual servo control method usually struggles to handle a fast-moving or irregularly moving dynamic target, resulting in problems of position prediction error and target mismatch.

A controlled autoregressive integrated moving average (CARIMA) model involves a method combining autoregressive (AR) and integrated moving average (IMA) features, and can predict a future position of a target by modeling historical data of a system and perform real-time correction based on an error. However, in the field of robotic visual control, there are no relevant applications of the CARIMA model. In view of this, how to use the CARIMA model to track a target in a dynamic environment with high precision and ensure that a robot accurately grabs the target has become a major challenge in visual servo control technology.

### SUMMARY

An objective of the present application is to provide a visual servo tracking method for a robotic arm, a device, a medium, a product, and a robot, so that accuracy of target tracking and stability of control can be improved in a dynamic environment, thereby resolving a problem that a robot cannot accurately grab a dynamic target when performing a visual servo tracking task.

To achieve the above objective, the present application provides the following technical solutions:

According to a first aspect, the present application provides a visual servo tracking method for a robotic arm, including:
obtaining a target position in real time based on machine vision to generate target position data;
constructing a position prediction model by using a CARIMA model;
generating a predicted value of the target position based on the target position data by using the position prediction model, and correcting the predicted value of the target position based on real-time feedback of target movement to obtain a predicted target position; and
adjusting a motion trajectory of the robotic arm based on an error between the predicted target position and a current target position of the robotic arm.

Optionally, the obtaining a target position in real time based on machine vision to generate target position data includes:
obtaining the target position in real time based on machine vision, and preprocessing the target position; and
forming the target position data based on the preprocessed target position.

Optionally, the preprocessing includes noise filtering and smoothing.

Optionally, the correcting the predicted value of the target position based on real-time feedback of target movement to obtain a predicted target position includes:
determining an increment of the current target position in combination with a historical increment based on the real-time feedback of the target movement; and
correcting a predicted value of the current target position based on the increment of the current target position to obtain the predicted target position.

Optionally, the increment of the target position is expressed as:

$$Δ y ( t ) = {θ}_{1} Δ y ( t - 1 ) + {θ}_{2} Δ y ( t - 2 ) + ⋯ + {θ}_{q} Δ y ( t - q ) + η ( t )$$

where, in the formula, Δy(t) represents an increment of the target position at a moment t, θ₁,θ₂, . . , and θ_{q} are all coefficients of an IMA part of the CARIMA model, η(t) is a prediction error of the position prediction model, and Δy(t−1), Δy(t−2), . . . , and Δy(t−q) respectively represent historical increments at moments t−1, t−2, . . . , and t-q.

Optionally, the adjusting a motion trajectory of the robotic arm based on an error between the predicted target position and a current target position of the robotic arm includes:
determining a trajectory correction based on the error between the predicted target position and the current target position of the robotic arm; and
adjusting the motion trajectory of the robotic arm based on the trajectory correction.

According to a second aspect, the present application provides a robot, including: a robot body, a visual sensor, a linear parameter time-varying predictive controller, and an incremental predictive controller, where
the visual sensor, the linear parameter time-varying predictive controller, and the incremental predictive controller are all provided on the robot body; the visual sensor is connected to the linear parameter time-varying predictive controller; the linear parameter time-varying predictive controller is connected to the incremental predictive controller; and the linear parameter time-varying predictive controller and the incremental predictive controller are integrated into an intelligent control unit of the robot body; and
the visual sensor is configured to obtain a target position in real time to generate target position data; the linear parameter time-varying predictive controller is equipped with a position prediction model and configured to generate a predicted value of the target position based on the target position data by using the position prediction model, and correct the predicted value of the target position based on real-time feedback of target movement to obtain a predicted target position; the position prediction model is constructed by using a CARIMA model; and the incremental predictive controller is configured to adjust a motion trajectory of a robotic arm based on an error between the predicted target position and a current target position of the robotic arm.

According to a third aspect, the present application provides a computer device, including: a memory, a processor, and a computer program stored in the memory and executable on the processor, where the processor is configured to execute the computer program to implement the steps of the visual servo tracking method for a robotic arm provided above.

According to a fourth aspect, the present application provides a computer-readable storage medium, storing a computer program, where when the computer program is executed by a processor, the steps of the visual servo tracking method for a robotic arm provided above are implemented.

According to a fifth aspect, the present application provides a computer program product, including a computer program, where when the computer program is executed by a processor, the steps of the visual servo tracking method for a robotic arm provided above are implemented.

According to specific embodiments provided in the present application, the present application has the following technical effects:

The present application provides a visual servo tracking method for a robotic arm, a device, a medium, a product, and a robot. Using a CARIMA model to construct a position prediction model to generate and correct a predicted value of a target position can effectively handle a time-varying feature of a dynamic target, so that accuracy of target tracking can be improved in a dynamic environment. Adjusting a motion trajectory of a robotic arm based on an error between a predicted target position and a current target position of the robotic arm can improve control accuracy of the robotic arm in grabbing a target, making it suitable for target grabbing and tracking tasks in a highly dynamic environment, thereby resolving a problem that a robot cannot accurately grab a dynamic target when performing a visual servo tracking task.

### BRIEF DESCRIPTION OF THE DRAWINGS

To describe the technical solutions in the embodiments of the present application or in the prior art more clearly, the following briefly describes the accompanying drawings required for the embodiments. Apparently, the accompanying drawings in the following description show merely some embodiments of the present application. A person of ordinary skill in the art may still derive other accompanying drawings from these accompanying drawings without creative efforts.

FIG. 1 is a schematic flowchart of a visual servo tracking method for a robotic arm according to an embodiment of the present application; and

FIG. 2 is a schematic structural diagram of a computer device according to an embodiment of the present application.

### DETAILED DESCRIPTION OF THE EMBODIMENTS

The technical solutions in the embodiments of the present application are clearly and completely described below with reference to the accompanying drawings in the embodiments of the present application. Apparently, the described embodiments are only some rather than all of the embodiments of the present application. All other embodiments obtained by a person of ordinary skill in the art based on the embodiments of the present application without creative efforts fall within the protection scope of the present application.

To make the above objectives, features, and advantages of the present application more obvious and easy to understand, the present application will be further described in detail with reference to the accompanying drawings and specific implementations.

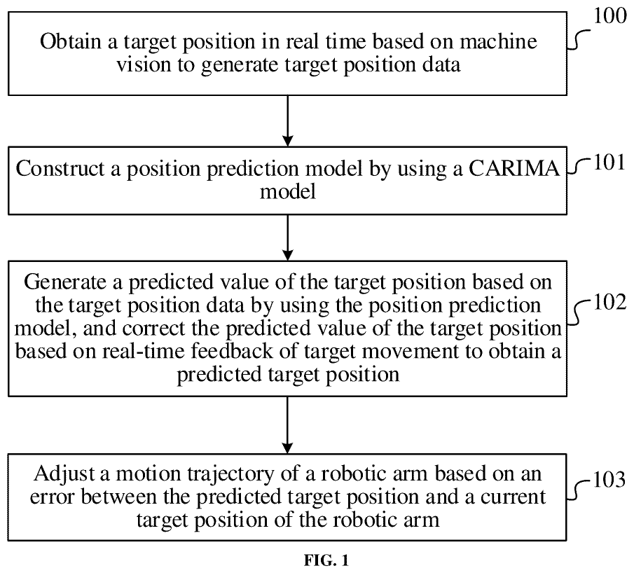

In an example embodiment, the present application provides a visual servo tracking method for a robotic arm. The method is performed by a computer device, and specifically, may be performed by a computer device such as a terminal or a server alone, or may be performed jointly by a terminal and a server. In this embodiment of the present application, description is provided by using an example in which the method is applied to a server. As shown in FIG. 1, the method includes the following steps:
In step 100, a target position is obtained in real time based on machine vision to generate target position data.
In step 101, a position prediction model is constructed by using a CARIMA model.
In step 102, a predicted value of the target position is generated based on the target position data by using the position prediction model, and the predicted value of the target position is corrected based on real-time feedback of target movement to obtain a predicted target position.
In step 103, a motion trajectory of the robotic arm is adjusted based on an error between the predicted target position and a current target position of the robotic arm.

In another example embodiment of the present application, to ensure that the robotic arm can accurately track and grab a target in a dynamic environment, in this embodiment, an implementation process of step 100 may be replaced by step 200 to step 203 below.

In step 200, a target position is obtained in real time based on machine vision. For example, position information of the target is captured in real time by using a machine vision device such as a camera, lidar, or a depth sensor. The position information of the target is a basis for establishment of a position prediction model and prediction control.

In step 201, the target position is preprocessed. For example, a preprocessing operation such as noise filtering or smoothing is performed on the obtained target position to remove external interference and improve accuracy of data. In addition, the preprocessing method may include Kalman filtering, low-pass filtering, and the like.

In step 202, target position data is formed based on the preprocessed target position.

In another example embodiment of the present application, the CARIMA model is mainly used to describe a dynamic system with a time-varying feature, especially in target trajectory prediction, where a future motion state of the target can be predicted based on historical data. The AR part of the CARIMA model mainly infers a movement pattern of the target by using current and past observation data. The IMA part of the CARIMA model mainly corrects a deviation in prediction by modeling the accumulation of errors. Based on this, to enable accurate prediction of the future motion state of the target by using the historical data, during the implementation of step 101 above, position data of the target is set to be y(t), and based on the CARIMA model, a prediction equation for the target position in the constructed position prediction model is:

$$y ( t ) = {ϕ}_{1} y ( t - 1 ) + {ϕ}_{2} y ( t - 2 ) + ⋯ + {ϕ}_{p} y ( t - p ) + ϵ ( t ) .$$

In the formula, φ₁, φ₂, . . . , and φₚ are AR coefficients of the CARIMA model, p is an order of AR, and ϵ(t) is an error term and has a moving average feature.

Further, for incremental predictive control, in step 102, the increment of the current target position may be determined in combination with the historical increment based on the real-time feedback of the target movement. The predicted value of the current target position is corrected based on the increment of the current target position to obtain the predicted target position.

For example, an increment Δy(t) of the target position at a moment t in the position prediction model may be predicted by using historical increments Δy(t−1), Δy(t−2), . . . , ∧Δy(t−q) as follows:

$$Δ y ( t ) = {θ}_{1} Δ y ( t - 1 ) + {θ}_{2} Δ y ( t - 2 ) + ⋯ + {θ}_{q} Δ y ( t - q ) + q ( t ) .$$

In the formula, θ₁,θ₂, . . . , and θ_{q} are all coefficients of the IMA part of the CARIMA model, and η(t) is a prediction error of the position prediction model.

During prediction of a future position of the target by using historical position data and incremental changes, assuming that the target position at the moment t is y(t), the increment Δy(t+1) of the target position is obtained through calculation of the AR part and the moving average part, and then, the predicted target position y(t+1) is calculated as follows:

$$y ( t + 1 ) = y ( t ) + Δ y ( t + 1 ) .$$

Based on the foregoing description, in the process of correcting the predicted value of the current target position based on the increment of the current target position to obtain the predicted target position, the predicted value is corrected based on real-time feedback of target movement. Whenever new target operation feedback information arrives, a predicted position of the target is recalculated and corrected based on the increment of the current target position. Such a real-time correction mechanism enables a continuous adjustment control policy in a dynamically changing environment.

In another example embodiment of the present application, if the position of the target deviates, the robot needs to adjust its motion trajectory to eliminate the error. Based on this, the implementation process of step 103 may be replaced by step 300 and step 301 below.

In step 300, a trajectory correction is determined based on the error between the predicted target position and the current target position of the robotic arm. A current pose of the robot is set to be p(t), the predicted value of the target position is set to be y(t+1), and a required trajectory correction is Δp(t) as follows:

$$Δ p ( t ) = K ( y ( t + 1 ) - p ( t ) ) ,$$

K is a gain matrix, and response sensitivity of the system is optimized by adjusting K.

In step 301, a motion trajectory of the robotic arm is adjusted based on the trajectory correction. Based on the adjusted motion trajectory information, an execution device (such as a robot) adjusts movement of the robotic arm through a motion control algorithm (such as inverse kinematics or dynamic control), thereby ensuring that the robotic arm can accurately track the target and perform a task such as target grabbing, article handling, or assembly.

In an example embodiment, based on the same inventive concept, the present application further provides a robot. The robot includes a robot body, a visual sensor, a linear parameter time-varying predictive controller, and an incremental predictive controller.

The visual sensor, the linear parameter time-varying predictive controller, and the incremental predictive controller are all provided on the robot body. The visual sensor is connected to the linear parameter time-varying predictive controller. The linear parameter time-varying predictive controller is connected to the incremental predictive controller. The linear parameter time-varying predictive controller and the incremental predictive controller are integrated into an intelligent control unit of the robot body.

The visual sensor is configured to obtain a target position in real time to generate target position data. The linear parameter time-varying predictive controller is equipped with a position prediction model and configured to generate a predicted value of the target position based on the target position data by using the position prediction model, and correct the predicted value of the target position based on real-time feedback of target movement to obtain a predicted target position. The position prediction model is constructed by using a CARIMA model. The incremental predictive controller is configured to adjust a motion trajectory of a robotic arm based on an error between the predicted target position and a current target position of the robotic arm.

The linear parameter time-varying predictive controller may be an incremental controller. The controller can predict a future position of a target by analyzing a historical motion trajectory of the target, and adjust the motion trajectory of the robotic arm based on the predicted values.

Further, the linear parameter time-varying predictive controller can eliminate a cumulative error in the system through incremental prediction, thereby avoiding a prediction deviation caused by uncertainty of target movement, and improving target tracking accuracy of the robotic arm.

The incremental predictive controller adjusts the motion trajectory of the robotic arm, and when the position of the target deviates, controls the robot body to adjust a motion trajectory thereof to eliminate the error. Based on corrected trajectory information, the robot body adjusts movement of the robotic arm through a motion control algorithm (such as inverse kinematics or dynamic control), thereby ensuring that the robotic arm can accurately track the target and perform a grabbing task.

In a preferable implementation, in an actual application process, the linear parameter time-varying predictive controller and the incremental predictive controller may be packaged, based on the visual servo tracking method for a robotic arm provided above in the present application, as a computer program unit, to be embedded into an existing robot intelligent control device to adjust and control the motion trajectory of the robotic arm of the existing robot.

In summary, the present application can effectively handle a time-varying feature of a dynamic target by using the CARIMA model. The conventional servo control method usually depends on a fixed model, but the CARIMA model can continuously update predictions based on historical data and perform error correction. Therefore, control accuracy of the present application is greatly improved, making it especially suitable for target grabbing and tracking tasks in a highly dynamic environment, thereby resolving a problem that a robot struggles to grab a dynamic target when performing a visual servo tracking task, and improving accuracy of target tracking and stability of control.

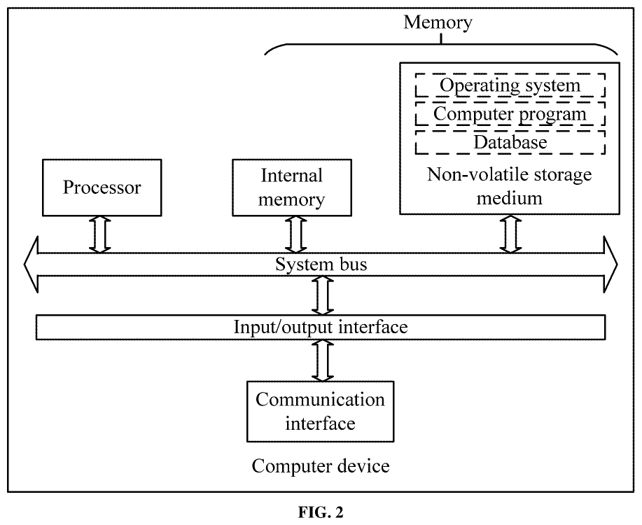

In an example embodiment, a computer device is provided. The computer device may be a server or a terminal, and an internal structure thereof may be as shown in FIG. 2. The computer device includes a processor, a memory, an input/output (I/O) interface and a communication interface. The processor, the memory, and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store visual servo tracking data for a robotic arm. The I/O interface of the computer device is configured for information exchange between the processor and an external device. The communication interface of the computer device is configured to communicate with an external terminal through a network connection. The computer program is executed by the processor to implement a visual servo tracking method for a robotic arm.

A person skilled in the art may understand that the structure shown in FIG. 2 is only a block diagram of a part of the structure related to the solutions of the present application and does not constitute a limitation on the computer device to which the solutions of the present application are applied. Specifically, the computer device may include more or fewer components than those shown in the figure, or some components may be combined, or a different component arrangement may be used. In an example embodiment, a computer device is provided, including a memory and a processor, where the memory stores a computer program, and the computer program is executed by the processor to implement the steps of the above method embodiment.

In an example embodiment, a computer-readable storage medium is provided, storing a computer program. When the computer program is executed by a processor, the steps of the above method embodiment are implemented.

In an example embodiment, a computer program product is provided, including a computer program. When the computer program is executed by a processor, the steps of the above method embodiment are implemented.

It should be noted that the information of a user (including but not limited to device information of the user, personal information of the user, and the like) and data (including but not limited to data for analysis, data for storage, data for exhibition, and the like) involved in the present application are all information and data authorized by the user or fully authorized by all parties, and collection, use, and processing of relevant data need to comply with relevant regulations.

A person of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the foregoing method may be performed. Any reference to a memory, a database, or other media used in the embodiments provided in the present application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration rather than a limitation, the RAM may be in various forms, such as a static random access memory (SRAM) or a dynamic random access memory (DRAM).

The databases involved in the embodiments provided in the present application may include at least one of a relational database and a non-relational database. The non-relational database may include a blockchain-based distributed database, but is not limited thereto. The processors involved in the embodiments provided in the present application may be general-purpose processors, central processing units, graphics processing units, digital signal processors, programmable logic devices, or data processing logic devices based on quantum computing, but are not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

Specific examples are used herein for illustration of the principles and implementations of the present application. The description of the foregoing embodiments is used to help understand the method of the present application and the core principles thereof. In addition, a person of ordinary skill in the art can make modifications in terms of the specific implementations and scope of application in accordance with the teachings of the present application. In conclusion, the content of the present specification should not be construed as a limitation to the present application.

What is claimed is:

1. A visual servo tracking method for a robotic arm, comprising:
obtaining a target position in real time based on machine vision to generate target position data;
constructing a position prediction model by using a controlled autoregressive integrated moving average (CARIMA) model;
generating a predicted value of the target position based on the target position data by using the position prediction model, and correcting the predicted value of the target position based on real-time feedback of target movement to obtain a predicted target position; and
adjusting a motion trajectory of the robotic arm based on an error between the predicted target position and a current target position of the robotic arm.

2. The visual servo tracking method for a robotic arm according to claim 1, wherein the obtaining a target position in real time based on machine vision to generate target position data comprises:
obtaining the target position in real time based on machine vision, and preprocessing the target position to obtain a preprocessed target position; and
forming the target position data based on the preprocessed target position.

3. The visual servo tracking method for a robotic arm according to claim 2, wherein the preprocessing comprises noise filtering and smoothing.

4. The visual servo tracking method for a robotic arm according to claim 1, wherein the correcting the predicted value of the target position based on real-time feedback of target movement to obtain a predicted target position comprises:
determining an increment of the current target position in combination with a historical increment based on the real-time feedback of the target movement; and
correcting a predicted value of the current target position based on the increment of the current target position to obtain the predicted target position.

5. The visual servo tracking method for a robotic arm according to claim 4, wherein the increment of the target position is expressed as:
$$Δ y ( t ) = {θ}_{1} Δ y ( t - 1 ) + {θ}_{2} Δ y ( t - 2 ) + … + {θ}_{q} Δ y ( t - q ) + η ( t )$$
wherein, Δy(t) represents an increment of the target position at a moment t, θ₁,θ₂, . . . , and θ_{q} are all coefficients of an integrated moving average (IMA) part of the CARIMA model, η(t) is a prediction error of the position prediction model, and Δy(t−1), Δy(t−2), . . . , and Δy(t−q) respectively represent historical increments at moments t−1, t−2, . . . , and t−q.

6. The visual servo tracking method for a robotic arm according to claim 1, wherein the adjusting a motion trajectory of the robotic arm based on an error between the predicted target position and a current target position of the robotic arm comprises:
determining a trajectory correction based on the error between the predicted target position and the current target position of the robotic arm; and
adjusting the motion trajectory of the robotic arm based on the trajectory correction.

7. A robot, comprising: a robot body, a visual sensor, a linear parameter time-varying predictive controller, and an incremental predictive controller, wherein
the visual sensor, the linear parameter time-varying predictive controller, and the incremental predictive controller are all provided on the robot body; the visual sensor is connected to the linear parameter time-varying predictive controller; the linear parameter time-varying predictive controller is connected to the incremental predictive controller; and the linear parameter time-varying predictive controller and the incremental predictive controller are integrated into an intelligent control unit of the robot body; and
the visual sensor is configured to obtain a target position in real time to generate target position data; the linear parameter time-varying predictive controller is equipped with a position prediction model and is configured to: generate a predicted value of the target position based on the target position data by using the position prediction model, and correct the predicted value of the target position based on real-time feedback of target movement to obtain a predicted target position; the position prediction model is constructed by using a controlled autoregressive integrated moving average (CARIMA) model; and the incremental predictive controller is configured to adjust a motion trajectory of a robotic arm based on an error between the predicted target position and a current target position of the robotic arm.

8. A computer device, comprising: a memory, a processor, and a computer program stored in the memory and executable on the processor, wherein the processor is configured to execute the computer program to implement the visual servo tracking method for a robotic arm according to claim 1.

9. A non-transitory computer-readable storage medium, storing a computer program, wherein when the computer program is executed by a processor, the visual servo tracking method for a robotic arm according to claim 1 is implemented.

10. The computer device according to claim 8, wherein the obtaining a target position in real time based on machine vision to generate target position data comprises:
obtaining the target position in real time based on machine vision, and preprocessing the target position to obtain a preprocessed target position; and
forming the target position data based on the preprocessed target position.

11. The computer device according to claim 10, wherein the preprocessing comprises noise filtering and smoothing.

12. The computer device according to claim 8, wherein the correcting the predicted value of the target position based on real-time feedback of target movement to obtain a predicted target position comprises:
determining an increment of the current target position in combination with a historical increment based on the real-time feedback of the target movement; and
correcting a predicted value of the current target position based on the increment of the current target position to obtain the predicted target position.

13. The computer device according to claim 12, wherein the increment of the target position
is expressed as:
$$Δ y ( t ) = {θ}_{1} Δ y ( t - 1 ) + {θ}_{2} Δ y ( t - 2 ) + … + {θ}_{q} Δ y ( t - q ) + η ( t )$$
wherein, Δy(t) represents an increment of the target position at a moment t, θ₁,θ₂, . . . , and θ_{q} are all coefficients of an integrated moving average (IMA) part of the CARIMA model, η(t) is a prediction error of the position prediction model, and Δy(t−1), Δy(t−2), . . . , and Δy(t−q) respectively represent historical increments at moments t−1, t−2, . . . , and t−q.

14. The computer device according to claim 8, wherein the adjusting a motion trajectory of the robotic arm based on an error between the predicted target position and a current target position of the robotic arm comprises:
determining a trajectory correction based on the error between the predicted target position and the current target position of the robotic arm; and
adjusting the motion trajectory of the robotic arm based on the trajectory correction.

15. The non-transitory computer-readable storage medium according to claim 9, wherein the obtaining a target position in real time based on machine vision to generate target position data comprises:
obtaining the target position in real time based on machine vision, and preprocessing the target position to obtain a preprocessed target position; and
forming the target position data based on the preprocessed target position.

16. The non-transitory computer-readable storage medium according to claim 15, wherein the preprocessing comprises noise filtering and smoothing.

17. The non-transitory computer-readable storage medium according to claim 9, wherein the correcting the predicted value of the target position based on real-time feedback of target movement to obtain a predicted target position comprises:
determining an increment of the current target position in combination with a historical increment based on the real-time feedback of the target movement; and
correcting a predicted value of the current target position based on the increment of the current target position to obtain the predicted target position.

18. The non-transitory computer-readable storage medium according to claim 17, wherein the
increment of the target position is expressed as:
$$Δ y ( t ) = {θ}_{1} Δ y ( t - 1 ) + {θ}_{2} Δ y ( t - 2 ) + … + {θ}_{q} Δ y ( t - q ) + η ( t )$$
wherein, Δy(t) represents an increment of the target position at a moment t, θ₁,θ₂, . . . , and θ_{q} are all coefficients of an integrated moving average (IMA) part of the CARIMA model, η(t) is a prediction error of the position prediction model, and Δy(t−1), Δy(t−2), . . . , and Δy(t−q) respectively represent historical increments at moments t−1, t−2, . . . , and t−q.

19. The non-transitory computer-readable storage medium according to claim 9, wherein the adjusting a motion trajectory of the robotic arm based on an error between the predicted target position and a current target position of the robotic arm comprises:
determining a trajectory correction based on the error between the predicted target position and the current target position of the robotic arm; and
adjusting the motion trajectory of the robotic arm based on the trajectory correction.
